(19) United States
(12) Patent Application Publication
(10) Pub. No.: US 2025/0148737 A1
(43) Pub. Date: May 8, 2025

(54) SYSTEMS AND METHODS FOR AUTOMATICALLY AND DYNAMICALLY LAYERING AND ADJUSTING VIRTUAL OBJECTS ON A DIGITAL AVATAR

(71) Applicant: Hologress LLC, Austin, TX (US)

(72) Inventors: Jordan Henry, Austin, TX (US); Graham Henry, Austin, TX (US)

(73) Assignee: Hologress LLC, Austin, TX (US)

(21) Appl. No.: 18/939,485

(22) Filed: Nov. 6, 2024

Related U.S. Application Data
(60) Provisional application No. 63/547,542, filed on Nov. 6, 2023.

(51) Int. Cl. G06T 19/20

(52) U.S. Cl. CPC G06T 19/20; G06T 2200/24; G06T 2210/21; G06T 2219/2016; G06T 2219/2021

(57) ABSTRACT

A system and computer-implemented method is provided for managing and transferring attire configurations on virtual entities in a virtual design environment. The method includes rendering a virtual entity as a three-dimensional digital model within a virtual entity design computing environment. A user applies multiple attire objects to the virtual entity in a specified sequence, and the system derives object sequencing metadata that records the order of attire application. A transferrable data container is configured to store representations of the attire objects along with the sequencing metadata. This data container enables the attire configuration, including object sequence and placement data, to be transmitted to and rendered in an interactive virtual environment distinct from the design environment, allowing for consistent appearance and behavior across different platforms.

### CROSS-REFERENCE TO RELATED APPLICATIONS

This application claims the benefit of U.S. Provisional Application No. 63/547,542, filed 6 Nov. 2023, which is incorporated herein in its entirety by this reference.

### TECHNICAL FIELD

The inventions herein relate generally to the computer generated graphics fields, and more specifically to a new and useful system and method for automatically and dynamically layering and adjusting virtual objects on a digital avatar in the computer generated graphics field.

### BACKGROUND

Virtual avatars are commonly used as digital representations of persons or other entities in a wide variety of modern computer generated environments such as virtual worlds, social media, and other similar digital platforms. In many cases, the customizability of the appearance of virtual avatars is a critical factor in the utility and presentation of virtual avatars in such computer generated environments. However, digital platforms are often deficient in providing customization options such as a variety of virtual clothing and accessories for virtual avatars. In addition, it is often difficult or impossible to mix or blend custom virtual clothing and accessory options from different sources, and such a blending of customized virtual clothing and accessory options often requires meticulously detailed manipulation of the virtual clothing and accessories of virtual avatars to avoid visual inconsistencies and virtual geometric interferences that may be beyond the ability of digital artists to perform or ameliorate manually.

Therefore, there is a need in the computer generated graphics field to create new and improved systems and methods for automatically and dynamically customizing the geometry of virtual clothing and accessories on virtual avatars. The embodiments of the present application described herein provide technical solutions that address, at least, the needs described above, as well as the deficiencies of the state of the art.

### BRIEF SUMMARY OF THE INVENTION(S)

In some embodiments, a computer-implemented method includes rendering, by one or more computer processors implementing a virtual entity design computing environment, a virtual entity comprising a three-dimensional digital representation of a geometric model. The method further includes applying, by the one or more computer processors in a user-determined sequence, a plurality of attire objects onto the virtual entity based on a plurality of inputs from a user. In response to the application of the plurality of attire objects, the method derives object sequencing metadata based on the user-determined sequence, where the object sequencing metadata identifies an order in which each of the plurality of attire objects was applied to the virtual entity. The method further configures, by the one or more computer processors, a transferrable data container that stores a representation of the plurality of attire objects and the object sequencing metadata and enables a transmission of the transferrable data container to an interactive virtual environment different from the virtual entity design computing environment.

In some embodiments, the method further includes fitting each attire object of the plurality of attire objects to a given geometric region of a plurality of geometric regions of the virtual entity, where the fitting of each attire object causes the respective attire object to change from a first n-dimensional geometric size to a second n-dimensional geometric size. Configuring the transferrable data container further includes storing, within the transferrable data container, the second n-dimensional geometric size of each of the plurality of attire objects based on the fitting.

In some embodiments, the method includes identifying n-dimensional coordinates for each attire object of the plurality of attire objects based on a placement of the respective attire object onto a given geometric region of a plurality of geometric regions of the virtual entity. Configuring the transferrable data container further includes storing, within the transferrable data container, the n-dimensional coordinates for each of the plurality of attire objects.

In some embodiments, the transferrable data container comprises at least a two-dimensional data structure storing attributes associated with the plurality of attire objects, wherein the at least two-dimensional data structure includes at least a first dimension storing a unique identifier for or a representation of a given attire object of the plurality of attire objects, and at least a second dimension storing one or more values of the attributes associated with the plurality of attire objects.

In some embodiments, the attributes associated with the plurality of attire objects include the object sequence metadata, a second n-dimensional geometric size of a given attire object of the plurality of attire objects, or n-dimensional coordinates of a placement of a given attire object of the plurality of attire objects onto the virtual entity.

In some embodiments, the method further includes analyzing, by the one or more computer processors, geometric intersections between a given attire object and an adjacent attire object of the plurality of attire objects placed on the virtual entity, and modifying, by the one or more computer processors, a geometric configuration of the given attire object and the adjacent attire object to resolve the geometric intersections based on the user-determined sequence.

In some embodiments, enabling the transmission of the transferrable data container further includes generating a platform-agnostic file format for the transferrable data container enabling the transferrable data container to be read and utilized by a plurality of different interactive virtual environments.

In some embodiments, fitting each attire object further includes performing collision detection between each attire object of the plurality of attire objects and the virtual entity to adjust the n-dimensional geometric size of a given attire object of the plurality of attire objects based on surface contours of the virtual entity.

In some embodiments, the method includes storing a history of modifications to the n-dimensional coordinates for each attire object of the plurality of attire objects stored within the transferrable container, thereby enabling a user to revert to a previous configuration of a given attire object of the plurality of attire objects.

In some embodiments, the transferrable data container further includes metadata specifying material properties of each attire object of the plurality of attire objects, where the material properties include one or more of a texture, color, and reflectivity of material, thereby ensuring consistency when rendered in the interactive virtual environment.

In some embodiments, the method further includes providing, by the one or more computer processors, a user interface allowing the user to adjust a position or an orientation of a given attire object of the plurality of attire objects after applying the given attire object to the virtual entity, and automatically updating the object sequencing metadata based on the adjustment by the user.

In some embodiments, procedural data are stored within the transferrable data container that define rules for automatically adjusting a position or a fit of a given attire object of the plurality of attire objects based on changes in a pose or a movement of the virtual entity in the interactive virtual environment.

In some embodiments, a computer-implemented system includes one or more computer processors; a virtual entity design computing environment implemented by the one or more computer processors, configured to render a virtual entity comprising a three-dimensional digital representation of a geometric model; a user interface module configured to receive, from a user, a plurality of inputs for applying a plurality of attire objects onto the virtual entity in a user-determined sequence; an object sequencing module configured to derive object sequencing metadata based on the user-determined sequence, where the object sequencing metadata identifies an order in which each of the plurality of attire objects was applied to the virtual entity; a data container module configured to configure a transferrable data container that stores a representation of the plurality of attire objects and the object sequencing metadata; and a transmission module configured to enable the transmission of the transferrable data container to an interactive virtual environment different from the virtual entity design computing environment.

In some embodiments, the system includes a fitting module configured to fit each attire object of the plurality of attire objects to a given geometric region of a plurality of geometric regions of the virtual entity, where the fitting of each attire object causes the respective attire object to change from a first n-dimensional geometric size to a second n-dimensional geometric size. The data container module is further configured to store, within the transferrable data container, the second n-dimensional geometric size of each of the plurality of attire objects based on the fitting.

In some embodiments, the system includes a coordinate identification module configured to identify n-dimensional coordinates for each attire object of the plurality of attire objects based on a placement of the respective attire object onto a given geometric region of a plurality of geometric regions of the virtual entity. The data container module is further configured to store, within the transferrable data container, the n-dimensional coordinates for each of the plurality of attire objects.

In some embodiments, the transferrable data container comprises at least a two-dimensional data structure storing attributes associated with the plurality of attire objects, where the at least two-dimensional data structure includes at least a first dimension storing a unique identifier for or a representation of a given attire object of the plurality of attire objects, and at least a second dimension storing one or more values of the attributes associated with the plurality of attire objects.

In some embodiments, a computer-program product comprises a non-transitory machine-readable medium comprising instructions that, when executed by a processor, perform operations comprising rendering, within a virtual entity design computing environment, a virtual entity comprising a three-dimensional digital representation of a geometric model; applying, in a user-determined sequence, a plurality of attire objects onto the virtual entity based on a plurality of inputs from a user; in response to the application of the plurality of attire objects, deriving object sequencing metadata based on the user-determined sequence, the object sequencing metadata identifying an order in which each of the plurality of attire objects was applied to the virtual entity; and configuring a transferrable data container that stores a representation of the plurality of attire objects and the object sequencing metadata, and enabling a transmission of the transferrable data container to an interactive virtual environment different from the virtual entity design computing environment.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application;

FIG. 3 illustrates an example implementation of a user interface for configuring a layering sequence in accordance with one or more embodiments of the present application;

FIG. 4 illustrates an example implementation of a user interface for configuring a layering sequence in accordance with one or more embodiments of the present application;

FIG. 5 illustrates an example implementation of a user interface for configuring a layering sequence in accordance with one or more embodiments of the present application;

FIG. 6 illustrates an example implementation of a user interface for switching virtual avatars while configuring a layering sequence in accordance with one or more embodiments of the present application; and

FIG. 7 illustrates an example implementation of a user interface for configuring a layering sequence in accordance with one or more embodiments of the present application.

### DESCRIPTION OF THE PREFERRED EMBODIMENTS

The following description of the preferred embodiments of the present application are not intended to limit the inventions to these preferred embodiments, but rather to enable any person skilled in the art to make and use these inventions.

### 1. System for Automatically and Dynamically Layering and Adjusting Virtual Objects on a Digital Avatar

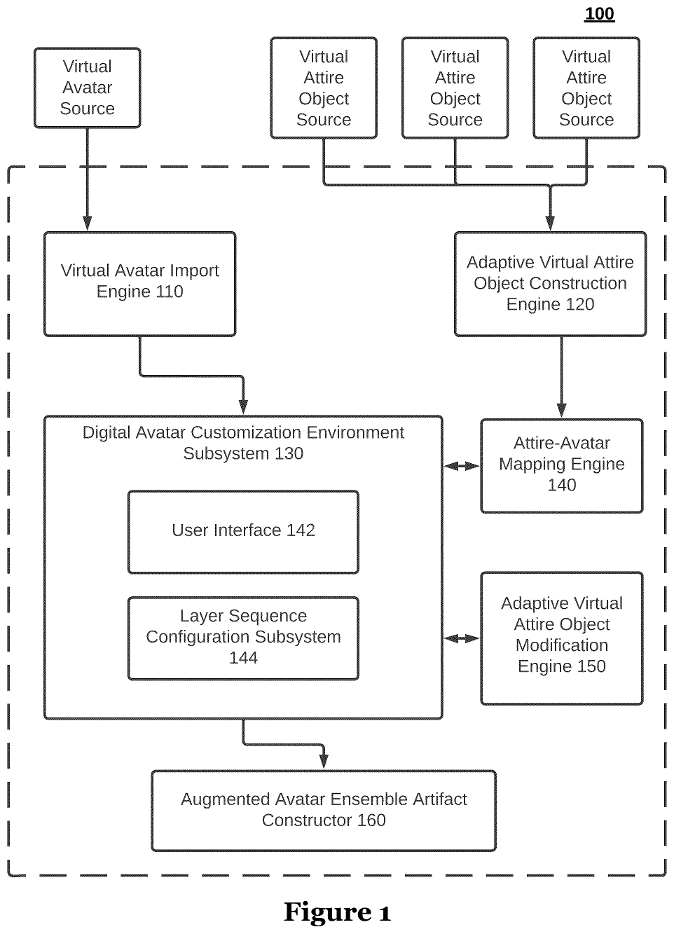

As shown in FIG. 1, a system 100 for automatically and dynamically layering and adjusting virtual objects on a digital avatar may include a virtual avatar import engine 110, an adaptive virtual attire object construction engine 120, a digital avatar customization environment subsystem 130, an attire-avatar mapping engine 140, an adaptive virtual attire object modification engine 150, and an augmented avatar ensemble artifact constructor 160.

### 1.1 Virtual Avatar Import Engine

The virtual avatar import engine 110 may preferably function to import, receive, and/or otherwise source one or more virtual or digital avatars from one or more sources of virtual or digital avatars. In some embodiments, virtual avatar import engine 110 may be in operable communication with one or more external sources of virtual or digital avatars (e.g., one or more external and/or remote servers, external networks, cloud storage, and/or the like). Additionally, or alternatively, in some embodiments, virtual avatar import engine 110 may be in operable communication with one or more local and/or internal sources of virtual or digital avatars (e.g., one or more local servers, local storage, and/or the like). In some preferred embodiments, virtual avatar import engine 110 may function to import virtual avatars in or based on one or more file types or formats that may represent or include 3D models or geometry, textures, materials, animations, and/or any other data or metadata that may be suitable for representing a digital avatar in a virtual 3-D environment.

### 1.2 Adaptive Virtual Attire Object Construction Engine

The adaptive virtual attire object construction engine 120 may preferably function to import, receive, and/or otherwise source one or more virtual attire objects from one or more sources of virtual or digital attire objects. In some embodiments, adaptive virtual attire object construction engine 120 may be in operable communication with one or more external sources of virtual or digital attire objects (e.g., one or more external and/or remote servers, external networks, cloud storage, and/or the like). Additionally, or alternatively, adaptive virtual attire object construction engine 120 may be in operable communication with one or more local and/or internal sources of virtual or digital attire objects (e.g., one or more local servers, local storage, and/or the like). In some preferred embodiments, adaptive virtual attire object construction engine 120 may function to import virtual attire objects in or based on one or more file types or formats that may represent or include 3D models or geometry, textures, materials, animations, and/or any other data or metadata that may be suitable for representing a digital attire object in a virtual 3-D environment.

In some preferred embodiments, adaptive virtual attire object construction engine 120 may additionally or alternatively function to construct adaptive virtual attire objects based on imported digital attire objects (e.g., static digital attire objects). In such embodiments, adaptive virtual attire object construction engine 120 may function to construct adaptive virtual attire objects that may include data and/or metadata that may represent, inform, or define one or more modifications of one or more geometric features (e.g., vertices, edges, polygons, and/or the like) of the geometry of the adaptive virtual attire object.

### 1.3 Digital Avatar Customization Environment Subsystem

Digital avatar customization environment subsystem 130 may preferably function to implement one or more interfaces and/or subsystems for displaying and managing data collected, generated, modified, or otherwise handled by system 100 to generate, modify, and/or customize one or more digital or virtual avatars. In various embodiments, digital avatar customization environment subsystem 130 may be in direct or indirect operable communication with virtual avatar import engine 110 and adaptive virtual attire object construction engine 120. In some such embodiments, digital avatar customization environment subsystem 130 may function to receive virtual avatar data from virtual avatar import engine 110 and adaptive virtual attire object data from adaptive virtual attire object construction engine 120.

In some preferred embodiments, digital avatar customization environment subsystem 130 may implement user interface 142 to enable one or more users to initiate, interact with, and receive output from system 100. In some preferred embodiments, user interface 142 may be implemented as a graphical user interface (GUI) and/or a web-based interface. Additionally, or alternatively, in some embodiments user interface 142 may visually display or otherwise output the geometry and/or geometric data of one or more digital avatars and/or the geometry and/or geometric data of one or more virtual or digital adaptive attire objects in a virtual three-dimensional space or environment.

In some preferred embodiments, digital avatar customization environment subsystem 130 may include layer sequence configuration subsystem 144. In such embodiments, layer sequence configuration subsystem 144 may function to configure and/or permit one or more users to configure a layering sequence of digital or virtual adaptive attire objects on one or more digital or virtual avatars that may be managed by digital avatar customization environment subsystem 130. In one or more embodiments, layer sequence configuration subsystem 144 may function to permit a user to edit or configure a layering sequence of digital or virtual adaptive attire objects in real-time, such that the results of modifying or changing the layering sequence may be displayed in real-time in digital avatar customization environment subsystem 130.

### 1.4 Attire-Avatar Mapping Engine

Attire-avatar mapping engine 140 may preferably function to geometrically arrange one or more adaptive virtual attire objects onto a target avatar of digital avatar customization environment subsystem 130 based on identifying one or more geometric regions of the target avatar that may correspond to one or more mapping regions of each adaptive virtual attire object. Accordingly, in some preferred embodiments, attire-avatar mapping engine 140 may be in operable communication with digital avatar customization environment subsystem 130. Additionally, in some embodiments, attire-avatar mapping engine 140 may be in operable communication with adaptive virtual attire object construction engine 120 such that one or more adaptive virtual attire objects constructed by adaptive virtual attire object construction engine 120 may be geometrically arranged on the target avatar. In one or more embodiments, attire-avatar mapping engine 140 may function to set and/or shift a location, scale, and/or rotation of each adaptive virtual attire object relative to the target avatar.

### 1.5 Adaptive Virtual Attire Object Modification Engine

Adaptive virtual attire object modification engine 150 may function to modify, adapt, or otherwise configure the geometric data of one or more adaptive virtual attire objects. In some embodiments, adaptive virtual attire object modification engine 150 may function to conduct one or more geometric intersection or interference analyses between adaptive virtual attire objects and/or between one or more adaptive virtual attire objects and a target avatar geometry based on a layering sequence. Accordingly, in one or more embodiments, adaptive virtual attire object modification engine 150 may receive as input the layering sequence from layer sequence configuration subsystem 144. In addition, adaptive virtual attire object modification engine 150 may function to non-destructively modify, adapt, or configure the geometric data of the one or more adaptive virtual attire objects, such that data and/or metadata relating to an original or pre-modified state of each adaptive virtual attire object is maintained or stored with data and/or metadata relating to an altered or post-modified state of each adaptive virtual attire object.

### 1.6 Augmented Avatar Ensemble Artifact Constructor

Augmented avatar ensemble artifact constructor 160 may function to generate or construct a digital augmented avatar ensemble artifact that may include data relating to an ensemble of adaptive virtual attire objects and a target virtual or digital avatar. In one or more embodiments, augmented avatar ensemble artifact constructor 160 may function to construct a portable data structure (e.g., a data file or the like) that may be deployed to one or more digital virtual platforms, such that an avatar augmented by adaptive virtual attire objects constructed and arranged by system 100 may be deployed in runtime or real-time environments. In some preferred embodiments, augmented avatar ensemble artifact constructor 160 may function to construct a digital augmented avatar ensemble artifact that may include data and/or metadata relating to an original or pre-modified state of each virtual object included in the ensemble artifact along with data and/or metadata relating to an altered or post-modified state of each virtual object included in the ensemble artifact, such that each virtual object included in the ensemble artifact is stored non-destructively. In one or more embodiments, augmented avatar ensemble artifact constructor 160 may function to include data relating to a layering sequence (as configured by layer sequence configuration subsystem 144), such that a layering configuration of adaptive virtual attire objects may be maintained and deployed with the augmented avatar.

### Additional Components (Not Shown) of System 100

System 100 may additionally, or alternatively include a plurality of modules, engines, and subsystems configured to facilitate the dynamic layering, adjusting, and transferring of virtual attire objects on a digital avatar within a virtual environment. The system comprises, among others, a virtual entity design computing environment, a user interface module, an object sequencing module, a data container module, a transmission module, and additional optional modules such as a fitting module and a coordinate identification module. Each component may interact with other components as necessary to achieve the overall functionality described.

### User Interface Module

The user interface module enables user interaction with the system, allowing users to upload, modify, and apply virtual attire objects to a virtual entity in a user-determined sequence. The interface may support real-time adjustments to layering sequences, positional arrangements, and geometric modifications, providing a visual and interactive representation of the avatar and attire objects within a 3D environment. Users can customize the attire object sequence through drag-and-drop manipulation, dropdown menus, or direct input.

### Object Sequencing Module

The object sequencing module generates and maintains metadata representing the sequence in which attire objects are applied to the virtual entity. This module derives object sequencing metadata based on user inputs, defining an ordered layering sequence that informs how attire objects overlay and interact on the avatar. The sequencing metadata may be updated dynamically as users alter the attire arrangement, ensuring that the configuration reflects real-time modifications.

### Data Container Module

The data container module is responsible for creating a transferrable data container that stores representations of the attire objects, the object sequencing metadata, and any additional attributes associated with the virtual entity and its attire configuration. This data structure may include a multi-dimensional format, where each attire object is identified by a unique identifier along with attributes such as geometric size, n-dimensional coordinates, and material properties (e.g., texture, color, reflectivity). The data container module supports non-destructive editing by maintaining both original and modified geometric states.

### Transmission Module

The transmission module enables the export or transmission of the transferrable data container to external, interactive virtual environments. The module is configured to support platform-agnostic file formats, allowing the attire configuration, including object sequence and placement data, to be rendered consistently across different platforms. This transmission capability ensures portability and interoperability of the avatar ensemble between design and deployment environments.

### Fitting Module

The fitting module, where implemented, is configured to adapt each attire object's geometry to fit specified geometric regions of the virtual entity. This module adjusts the size, rotation, and positioning of each attire object based on its mapping to the avatar's geometry, causing each attire object to transition from a first n-dimensional size to a second n-dimensional size. The fitting module may also perform collision detection between attire objects and the virtual entity to prevent visual or spatial interference.

### Coordinate Identification Module

The coordinate identification module identifies the n-dimensional coordinates of each attire object relative to the virtual entity. This module records positional data for each attire object as it is applied, storing the coordinates in the transferrable data container for use in rendering and spatial arrangement within the interactive virtual environment.

### Additional Functional Features

In various embodiments, the system may include additional functional features, such as:

Geometric intersection analysis and modification for analyzing and resolving geometric intersections between adjacent attire objects or between attire objects and the virtual entity. The system may automatically modify the geometric configuration of attire objects based on the layering sequence to prevent overlapping or clipping.

Real-time layering sequence adjustment that enables real-time adjustment capabilities for layering sequences, allowing the user to view and rearrange attire objects dynamically. This feature ensures immediate visual feedback on modifications to the attire sequence.

Material properties and attributes storage within the data container. Accordingly, the data container may include material properties for each attire object, such as texture, color, and reflectivity. These properties ensure consistent rendering of attire objects when transferred to different virtual environments.

History and procedural data storage within the data container. System 100 may store a history of modifications to each attire object's coordinates, enabling users to revert to prior configurations. Additionally, procedural data may define rules for automatically adjusting attire based on changes in the virtual entity's pose or movement within the virtual environment.

Cross-platform compatibility by generating a platform-agnostic data format, system 100 supports seamless transfer of attire configurations to various interactive virtual environments, ensuring that appearance and layering integrity are preserved across platforms.

System 100's data structures may be designed to store both original and modified states of attire objects non-destructively. This enables flexibility for iterative modifications and ensures that original attire configurations are preserved alongside any adaptations applied during use.

### 2. Method for Automatically and Dynamically Layering and Adjusting Virtual Objects on a Digital Avatar

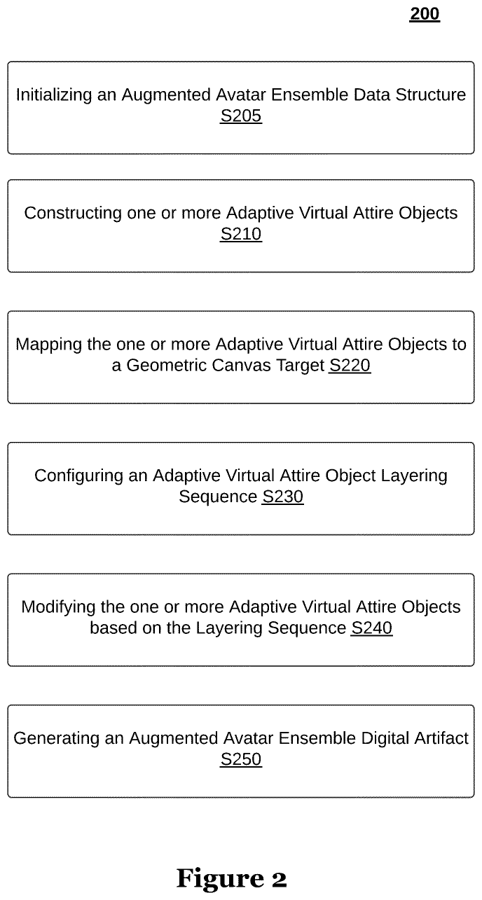

As shown in FIG. 2, a method 200 for automatically and dynamically layering and adjusting virtual objects on a digital avatar includes initializing an augmented avatar ensemble data structure S205, constructing one or more adaptive virtual attire objects S210, mapping the one or more adaptive virtual attire objects to a geometric canvas target S220, configuring an adaptive virtual attire object layering sequence S230, modifying the one or more adaptive virtual attire objects based on the layering sequence S240, and generating an augmented avatar ensemble digital artifact S250.

### 2.05 Initializing an Augmented Avatar Ensemble Data Structure

S205, which includes initializing an augmented avatar ensemble data structure, may function to initialize an augmented avatar ensemble data structure in a digital avatar customization environment. An augmented avatar ensemble data structure, as generally referred to herein, may relate to a data structure that may store one or more pieces of data and/or metadata relating to a digital or virtual avatar, and/or one or more pieces of data and/or metadata relating to digital or virtual attire associated with or mapped to the digital or virtual avatar. A digital avatar customization environment, as generally referred to herein, may relate to a digital environment that may include and/or implement a user interface that may function to permit one or more users to design, modify, and/or customize one or more elements of a digital or virtual avatar ensemble.

### Augmented Avatar Ensemble Data Structure

Preferably, S205 may function to initialize the augmented avatar ensemble data structure based on a canvas avatar target (sometimes referred to herein as a “canvas target” or “target avatar”) and/or one or more pieces of virtual attire including, but not limited to, virtual accessories, apparel, and/or objects associated with the canvas avatar target. As generally referred to herein, a canvas avatar target may relate to a digital or virtual avatar that may include, but is not limited to, a digital or virtual human-like character, animal, object, and/or the like. In various embodiments, the augmented avatar ensemble data structure may include data from or based on the canvas avatar target including, but not limited to, geometry data that may define a geometry of the canvas avatar target and/or one or more virtual accessories, attire, and/or objects associated with the canvas avatar target (e.g., one or more 3-D models or meshes of the virtual avatar and/or 3-D models or meshes of attire, accessories, and other objects related to the virtual avatar), texture and/or material data that may define one or more textures or materials of the avatar target and/or one or more virtual accessories, attire, and/or objects associated with the canvas avatar target (e.g., one or more textures or materials of the virtual avatar and/or of attire, accessories, and other objects related to the virtual avatar), animation data (e.g., skeletal or rigging data, predefined animations or animation data, and/or the like), and/or any other data that may define or otherwise inform a construction and/or appearance of the canvas avatar target and/or one or more virtual accessories, attire, and/or objects associated with the canvas avatar target.

Additionally, in some preferred embodiments, the augmented avatar ensemble data structure may include one or more pieces of ensemble augmenting data and/or metadata (sometimes referred to herein as “augmenting data” and/or “augmenting metadata”) relating to an augmentation or modification of one or more elements of the augmented avatar ensemble data structure. In some such embodiments, the augmenting data and/or metadata may inform or define one or more modifications of an original unmodified shape, structure, or appearance of one or more elements of the augmented avatar ensemble data structure (such as a shape, structure, or appearance of one or more items of virtual attire, accessories, and other objects related to the virtual avatar). In some such embodiments, the augmented avatar ensemble data structure may include data relating to both an original unmodified shape, structure, or appearance of one or more elements of the augmented avatar ensemble data structure as well as augmenting data and/or metadata defining one or more modified shapes, structures, or appearances of any or each of the one or more elements of the augmented avatar ensemble data structure. Accordingly, the augmented avatar ensemble data structure may permit non-destructive storing of modifications to the shapes, structures, or appearances of the virtual elements of the augmented avatar ensemble data structure by storing both original shape, structure, or appearance data and augmenting data relating to any or all modifications of the shapes, structures, or appearances of the elements of the augmented avatar ensemble data structure.

As a non-limiting example, the augmented avatar ensemble data structure may include data relating to a virtual avatar wearing virtual clothing. In such an example, the shape of one or more elements of virtual clothing may be modified (e.g., in the digital avatar customization environment, and/or any other runtime or real-time environment). In such an example, the augmented avatar ensemble data structure may include data relating to the original shape of the one or more elements of modified virtual clothing (i.e., a pre-modified shape or state of the one or more elements of modified virtual clothing) as well as augmenting data and/or metadata relating to the modified shape(s) of the one or more elements of modified virtual clothing or virtual components of a costume. Accordingly, in such an example, the augmented avatar ensemble data structure may function to store both the unmodified (i.e., pre-modified) and modified shapes or states of the one or more elements of modified virtual clothing.

### Digital Avatar Customization Environment

Preferably, S210 may function to initialize the augmented avatar ensemble data structure in a digital avatar customization environment. In one or more embodiments, the digital avatar customization environment may include a user interface (e.g., a GUI or the like) that may function as a runtime or real-time environment for displaying the virtual avatar and one or more pieces of attire, accessories, and other objects associated with the virtual avatar that may be included in the augmented avatar ensemble data structure in a virtual 3-D space (e.g., a real-time 3-D virtual space, virtual environment, or viewer). Additionally, in some preferred embodiments, the user interface of the digital avatar customization environment may permit a user to customize, modify, or otherwise configure the virtual avatar and any or all attire, accessories, and other objects associated with the virtual avatar. In some such embodiments, the user interface may display any modifications in real-time, and/or the augmented avatar ensemble data structure may be modified in real-time; that is, as a user modifies the virtual avatar and/or attire, accessories, or other objects associated with the virtual avatar, those modifications may be displayed in real-time and/or those modifications may be appended to or otherwise stored in the augmented avatar ensemble data structure (e.g., as augmenting data and/or augmenting metadata).

In some embodiments, a user may utilize the digital avatar customization environment to upload or import a digital or virtual avatar asset or object that may function as the canvas avatar target. In such embodiments, the uploaded or imported digital or virtual avatar may include geometry data, texture and/or material data, animation data, and/or any other data relating to a digital or virtual avatar. In one or more embodiments, a digital or virtual avatar may be uploaded or imported from a 3-D model file (e.g., a .fbx file, .obj file, .dae file, and/or the like). In some such embodiments, the uploaded or imported digital or virtual avatar data may be appended to or otherwise incorporated into the augmented avatar ensemble data structure.

2.1 Constructing one or more Adaptive Virtual Attire Objects

S210, which includes constructing one or more adaptive virtual attire objects, may function to construct one or more adaptive virtual attire objects (sometimes referred to herein as “adaptive digital attire objects” or “adaptive attire objects”) based on collected or imported geometric object data from one or more digital or virtual geometric attire objects. An adaptive virtual attire object, as generally referred to herein, may relate to a digital 3-D geometric attire object (e.g., a 3-D model or the like) that may represent one or more pieces of virtual attire for a virtual avatar and may include geometric data that may be automatically and/or dynamically adjusted, conformed, or otherwise modified. In some preferred embodiments, each adaptive attire object may be automatically and/or dynamically adjusted, conformed, or otherwise modified to fit one or more virtual or digital geometric constraints. Preferably, the one or more virtual or digital geometric attire objects may be 3-D objects (e.g., 3-D models or the like). In some preferred embodiments, the one or more adaptive attire objects may relate to one or more 3-D models that may represent digital or virtual clothing, accessories, and/or other items that may be wearable or otherwise equipped by a digital or virtual 3-D avatar, persona, and/or the like.

In one or more preferred embodiments, the adaptive attire objects may include data relating to a digital 3-D geometric attire object. In such embodiments, each adaptive attire object may include geometry data (and/or geometry metadata) that may relate to or define a 3-D geometry (e.g., a 3-D mesh or the like) of the adaptive attire object. In various embodiments the geometry data may include, but not may not be limited to, vertex data (e.g., coordinates that may define one or more vertices of the 3-D geometric structure of the adaptive attire object), topological data (e.g., indices or vertex identifiers that may define geometric edges, faces, polygons, and/or the like of the adaptive attire object), and/or any other suitable data or metadata that may define a 3-D geometry or 3-D mesh of the adaptive attire object. Additionally, in some embodiments, the one or more adaptive attire objects may include data relating to textures, materials, and/or the like that may define or otherwise inform a visual appearance of the one or more adaptive attire objects.

In some embodiments, each adaptive attire object may include data and/or metadata (e.g., a tag, label, and/or the like) that may identify one or more geometric mapping regions (mapping regions) of the adaptive attire object. In such embodiments, a mapping region may relate to a geometric region of a target virtual avatar, target canvas object, and/or the like that the adaptive attire object may be n-dimensionally mapped to. In some embodiments, the mapping region may correspond to a component or element of a target avatar geometric framework. As a non-limiting example, a target avatar may include a 3-D skeletal mesh that may include one or more bones or the like, and each adaptive attire object may be mapped to one or more mapping regions corresponding to one or more bones of the 3-D skeletal mesh. It shall be noted that the above example is non-limiting, and the one or more mapping regions may include or relate to any suitable geometric region or the like.

In some embodiments, the adaptive attire object may include data and/or metadata that may relate to one or more geometric adjustments, conformations, adaptations, and/or other geometric modifications of the 3-D geometry of the adaptive attire object. In such embodiments, the data and/or metadata that may relate to such modifications may represent a modified geometry of the adaptive attire object. That is, in some such embodiments, the adaptive attire object may include data and/or metadata relating to an original unmodified geometry, and additionally (or, in some embodiments, alternatively) the adaptive attire object may include data and/or metadata relating to a conformed, adapted, or otherwise modified geometry.

Collecting and/or Importing Adaptive Attire Objects

In a first implementation, S210 may function to construct one or more adaptive attire objects based on collected or imported geometric object data from one or more imported static geometric attire objects (sometimes referred to herein as imported virtual objects or imported geometric objects). In such an implementation, the imported static geometric objects may be 3-D geometric objects (e.g., 3-D models or the like) stored in a 3-D geometric data structure or file (e.g., FBX, OBJ, DAE, and/or any other suitable file types for storing 3-D geometry data), and each geometric object may include set or static geometry data that may relate to a 3-D geometry of the object. In some embodiments, one or more of the adaptive attire objects may be constructed based on one or more collected or imported geometric objects. In some such embodiments, one or more of the adaptive attire objects may be constructed by transforming or otherwise converting one or more imported or collected static geometric virtual objects to an adaptive attire object format or data structure (e.g., a format or data structure that may store or include geometric data that may be adjusted, conformed, or otherwise modified to fit one or more geometric constraints).

In a second implementation, S210 may function to collect or import one or more preconstructed adaptive attire objects. That is, in such an implementation, one or more of the adaptive attire objects may be directly imported or collected without the need for construction, based on a previous iteration or operation of S210 and/or method 200 that may have previously constructed one or more adaptive attire objects. It shall be noted that, in some embodiments, S210 may function to construct one or more adaptive attire objects as well as collect one or more pre-constructed adaptive attire objects. That is, in some embodiments, the one or more constructed adaptive attire objects may include one or more preconstructed adaptive attire objects (e.g., adaptive attire objects constructed during a prior iteration or execution of S210) and one or more adaptive attire objects constructed by the current iteration or execution of S210.

### Constructing Adaptive Attire Objects: User Interface

In some preferred embodiments, a user interface, such as a graphical user interface (GUI), may be implemented by S210 and/or method 200 (e.g., in the digital avatar customization environment, as described in 2.05). In some such preferred embodiments, collected or imported static geometric attire objects may be arranged (e.g., as icons, images, and/or the like) in an attire object palette or region of the GUI. In some such embodiments, static geometric attire objects may be identified and/or selected via the user interface (e.g., by clicking on a selectable interface object representing a static geometric attire object, and/or by click-and-drag manipulation of icons, images, and/or the like representing a static geometric attire object), and in turn S210 may function to construct the one or more adaptive attire objects based on the geometric objects selected or identified in the user interface. As a non-limiting example, in some embodiments, a user may click on an icon representing a static geometric attire object and drag the icon onto the canvas target (e.g., the canvas target as displayed in a 3-D virtual space or viewport), and S210 may accordingly function to automatically construct an adaptive attire object based on that static geometric attire object. Additionally, or alternatively, in some such embodiments, one or more pre-constructed adaptive attire objects may be arranged in the attire object palette or region of the GUI, and the one or more pre-constructed adaptive attire objects may be similarly identified and/or selected via the user interface. In some embodiments, each static geometric object and/or each adaptive attire object may be represented by an icon, image, text label, and/or any other suitable user interface object.

As a non-limiting example, a user interface may include one or more icons that may each represent a distinct static geometric attire object or pre-constructed adaptive attire object. In such an example, a user may select (e.g., by clicking, click-and-drag manipulation, drag-and-drop manipulation, checkbox, drop-down list, and/or other selectable user interface mechanism) one or more distinct static geometric attire objects to be converted to adaptive attire objects. In such an example, S210 may function to construct one or more adaptive attire objects based on the one or more selected distinct static geometric attire objects. Additionally, or alternatively, in such an example, a user may select one or more distinct pre-constructed adaptive attire objects, such that S210 may function to collect or import the one or more selected distinct preconstructed adaptive attire objects.

2.2 Mapping the one or more Adaptive Virtual Attire Objects to a Geometric Canvas Target

S220, which includes mapping the one or more adaptive virtual attire objects to a canvas target, may function to map the geometric data of each of the one or more conformable content model objects to the canvas target based on one or more pieces of data and/or metadata of the geometric target. In some preferred embodiments, the canvas target may define one or more geometric constraints of the adaptive attire objects. In one or more embodiments, the canvas target may be defined by the augmented avatar ensemble data structure (as described in 2.05). In some preferred embodiments, the geometric data and/or any other data and/or metadata that may define or otherwise inform a virtual appearance of the one or more adaptive attire objects may be appended to or otherwise included in the augmented avatar ensemble data structure.

In one or more embodiments, S220 may function to identify one or more geometric regions of the canvas target that may correspond to one or more mapping regions of the one or more adaptive attire objects. A geometric region of the canvas target, as generally referred to herein, may relate to a region of the canvas target geometry (e.g., a volume of the canvas target 3-D mesh, a subset of vertices, edges, and/or polygons of the 3-D mesh, a 3-D virtual spatial location of the canvas target geometry, and/or the like). In some embodiments, each of the one or more geometric regions of the canvas target may be defined by or otherwise based on a component or element of a target avatar geometric framework. As a non-limiting example, a canvas target (e.g., a target avatar) may include a 3-D skeletal mesh that may include one or more bones or the like, wherein each bone, or a subset of bones, may define or inform a geometric region of the canvas target (e.g., each bone or subset of bones may be associated with one or more vertices, edges, and/or polygons of the 3-D mesh of the canvas target). Alternatively, in some embodiments, one or more of the one or more geometric regions of the canvas target may be defined by a user (e.g., by interacting with the canvas target via the user interface).

Preferably, each of the one or more adaptive attire objects may be automatically mapped spatially and/or geometrically to the canvas target based on associating the one or more mapping regions of the adaptive attire object to one or more corresponding geometric regions of the canvas target. In one or more such embodiments, each of the one or more adaptive attire objects may be positioned spatially relative to the respective corresponding one or more geometric regions of the canvas target in a particular predefined alignment (e.g., by automatically setting coordinate values of each adaptive attire object in a 3-D coordinate virtual space to be centered relative to each respective corresponding geometric region(s)).

As a non-limiting example, an adaptive attire object may be associated with one or more mapping regions (e.g., based on one or more pieces of mapping region data and/or metadata associated with the adaptive attire object). In such an example, the one or more mapping regions may correspond to one or more geometric regions of the canvas target (e.g., a “right shoulder” mapping region of the adaptive attire object may correspond to a “right shoulder” geometric region of the canvas target). In such an example, the adaptive attire object may be geometrically and/or spatially positioned or arranged in 3-D coordinate space (e.g., x, y, and z coordinates, and/or the like) at a location of the canvas target that corresponds to the one or more geometric regions based on a mapping of the one or more mapping regions of the adaptive attire object to one or more geometric regions of the canvas target. In such an example, the positioning or arranging of the adaptive attire object may include setting one or more location values or coordinates of the adaptive attire object in a 3-D coordinate space and/or setting one or more rotation values or coordinates of the adaptive attire object, such that the adaptive attire object may be arranged in a position and/or rotation relative to the canvas target that may be defined or based on the mapping of the one or more mapping regions of the adaptive attire object to the one or more geometric regions of the canvas target. Additionally, or alternatively, in such an example, the adaptive attire object may be scaled (e.g., sized up or sized down) along each axis in the 3-D coordinate space based on a sizing and/or scaling of geometric regions of the canvas target relative to the geometry of the adaptive attire object (e.g., if a mapping region of the adaptive attire object is longer along a particular axis (e.g., x, y, or z axis, and/or the like) than a corresponding geometric region of the canvas target, the adaptive attire object may be scaled down along that particular axis to match the scale of the canvas target).

Preferably, S220 may function to display the one or more adaptive attire objects in their relative mapped positions, rotations, and scales on the canvas target in a real-time 3-dimensional virtual space or viewport of the user interface (e.g., of the digital avatar customization environment). In some such embodiments, a user may further manipulate, customize, or otherwise modify a position, rotation, and/or scale of each adaptive attire object by click-and-drag manipulation of the adaptive attire objects in the user interface, by direct text or numerical input of position, rotation, and/or scale values, and/or any other suitable mechanism for changing a position, rotation, and/or scale of a virtual object in a virtual environment. In such embodiments, user-customized or user-modified positions, scales, and/or rotations of an adaptive attire object may override the automatically mapped position, rotation, and/or scale of the adaptive attire object.

In one or more preferred embodiments, the data (e.g., geometric data, texture/material data, and/or the like) of each of the adaptive attire objects may be appended to or otherwise included in the augmented avatar ensemble data structure. In some such preferred embodiments, the augmented avatar ensemble data structure may include data from both a pre-mapped state (i.e., an original scale, rotation, and position before mapping to the target avatar) and a post-mapped and/or post-user customization state for each adaptive attire object. In some such embodiments, the augmented avatar ensemble data structure may store one or more post-mapped and/or user-customized scale, position, and/or rotation values for each adaptive attire object as augmenting data and/or augmenting metadata associated with each adaptive attire object. Accordingly, in such embodiments, the augmented avatar ensemble data structure may store original geometric data (i.e., the original state of the adaptive attire object) and modified, mapped, or customized geometric data for each adaptive attire object. Alternatively, in some embodiments, the augmented avatar ensemble data structure may store only post-mapped and/or user-customized geometric states (i.e., positions, scales, and/or rotations) for each adaptive attire object.

### 2.3 Configuring an Adaptive Virtual Attire Object Layering Sequence

S230, which includes configuring an adaptive virtual attire object layering sequence (layering sequence) based on the one or more adaptive attire objects, may function to construct and/or configure a layering sequence based on the one or more mapped adaptive attire objects. A layering sequence, as generally referred to herein, may relate to an ordered list of one or more adaptive attire object layers that may function to define a geometric layering of the one or more mapped adaptive attire objects based on the sequence or order of object layers. Preferably, each adaptive attire object layer of the layering sequence may represent or be associated with one or more mapped adaptive attire objects.

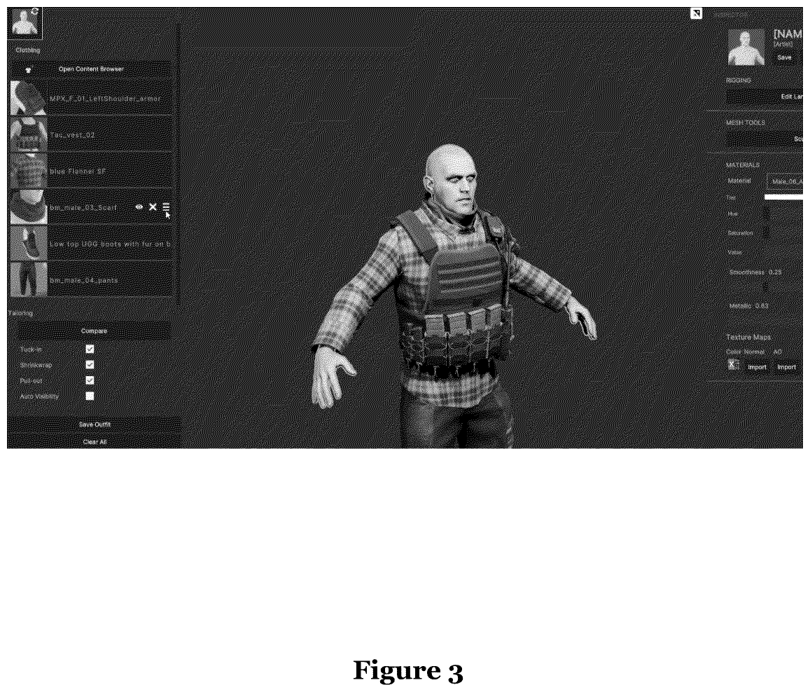

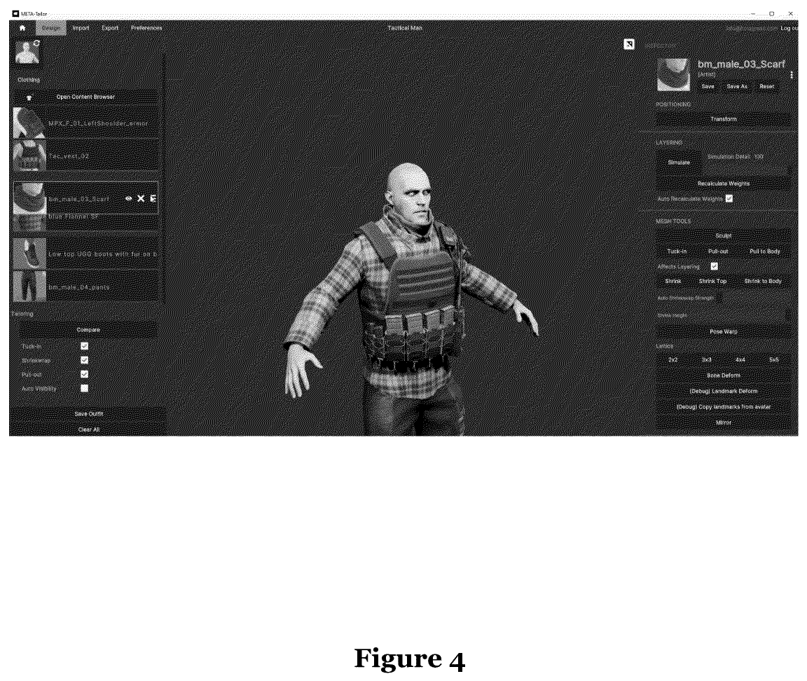

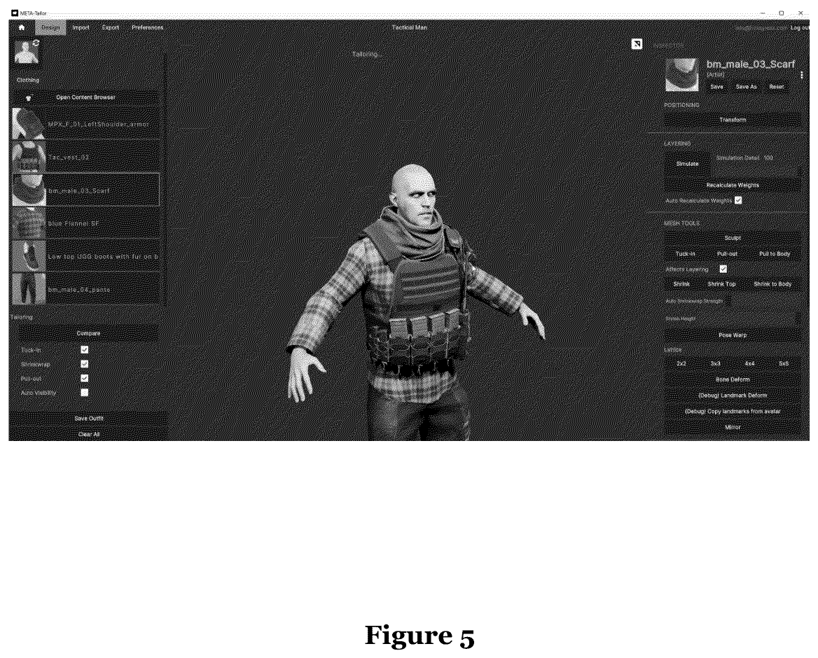

In some preferred embodiments, a user may modify, adjust, or configure the layering sequence via the user interface (e.g., via the digital avatar customization environment interface), as shown by way of example in FIGS. 3-7. In some such embodiments, the layering sequence may be displayed and/or otherwise represented by a visual representation of a list or grouping of adaptive attire object layers. In some such preferred embodiments, each adaptive attire object layer may be represented by a layer interface object that may include an icon, an image, a text label, a button, and/or any other suitable user interface object or combination thereof, such that the layering sequence may be represented by a group or list of layer interface objects. In some embodiments, the group or list of layer interface objects may be arranged in a vertical list or array. Alternatively, the group or list of layer interface objects may be arranged in a horizontal list or array, or any other suitable visual arrangement or grouping of interface objects. In some embodiments, an adaptive attire object may be automatically associated with an adaptive attire object layer upon mapping to the canvas target (as described in 2.2).

In some implementations, the layering sequence may be represented by a list of layer interface objects in the user interface (e.g., a vertical or horizontal list). Alternatively, in some implementations, the layering sequence may be represented by a non-ordered grouping of layer interface objects in the user interface (e.g., a matrix, a cluster, and/or the like).

In some embodiments, a user may arrange or sort the adaptive attire object layers in the list as desired, e.g., by drag-and-drop manipulation or the like of the layer interface objects, wherein the arrangement of layer interface objects in the list defines the layering sequence based on the adaptive attire objects associated with each layer interface object. Additionally, or alternatively, in some embodiments, each layer interface object may be associated with one or more adaptive attire objects, and each layer interface object include or be associated with a number (e.g., 1, 2, 3), a character (e.g., A, B, C), or other likewise enumerator that may function to identify an order of the layering sequence. In some such embodiments, a user may select an enumerator for each layer interface object (e.g., via a selection control such as a dropdown list, radio buttons, and/or the like) and/or directly input an enumerator for each layer interface object, such that the user-selected and/or user-input enumerators may define an order of the layering sequence.

In some preferred embodiments, the layering sequence may be appended to or otherwise included in the augmented avatar ensemble data structure as layering sequence data and/or layering metadata. In some embodiments, the layering sequence includes metadata for each item of virtual clothing or virtual component of a costume attributed to a target canvas. In such embodiments, the layer sequence defines a collection of a plurality of distinct metadata of virtual clothing intended for a target virtual canvas that is stored with additional order or sequencing metadata that defines a reconstruction order or a virtual clothing rendering order between the plurality of distinct metadata. In one or more embodiments, metadata and/or computer-executable instructions for the reconstruction order or the virtual clothing rendering order may be generated or created based on positional or n-dimensional data of each of the plurality of virtual clothing items. In a non-limiting example, the plurality of virtual clothing items includes a first virtual item with layering metadata indicating its arrangement directly against a target canvas, a second virtual item with layering metadata indicating its arrangement against a surface of the first virtual item, and a third virtual item with layering metadata indicating its arrangement against a surface of the second virtual item. In such example, a system (e.g., system 100) or service implementing the method 200 may function to reconcile the 3 virtual items and generate additional layering metadata that enumerates a reconstruction order of the virtual items such that, when the layering metadata is read or executed from a stored state, the first virtual item is rendered first to a target canvas, the second virtual items is rendered second, and the third virtual item is rendered third such that the layering order at a creation of the virtual clothing items is preserved at a re-creation or re-rendering of the virtual clothing items.

Additionally, or alternatively, the layering sequence data and/or metadata may include the layering sequence of each adaptive attire object included in the augmented avatar ensemble data structure. Preferably, the layering sequence data and/or metadata of the augmented avatar ensemble data structure may be updated in real-time relative to user configuration of the layering sequence and/or the addition, modification, and/or removal of one or more adaptive attire objects from the canvas target.

### 2.4 Modifying the One or More Adaptive Virtual Attire Objects Based on the Layering Sequence

S240, which includes modifying the one or more adaptive virtual attire objects based on the layering sequence, may function to implement or execute the layering sequence in real-time by modifying the geometric data of one or more adaptive attire objects mapped to the canvas target based on the geometric layering defined by the layering sequence. Preferably, S240 may function to evaluate one or more adaptive attire object layers of the layering sequence, and S240 may in turn function to modify a geometry of one or more adaptive attire objects based on geometric interferences between adaptive attire objects in different layers of the layering sequence as well as geometric interferences between adaptive attire objects and the canvas target.

In some preferred embodiments, S240 may function to step or iterate through each adaptive attire object layer of the layering sequence in a sequence (e.g., in the layer order defined by the arrangement of the layering sequence). In some such embodiments, S240 may function to modify the geometry data of each adaptive attire object of each adaptive attire object layer based on geometric constraints of the canvas target. Preferably, S240 may function to identify one or more geometric intersections or collisions between each distinct adaptive attire object in a current adaptive attire object layer and the canvas target. In such embodiments, upon identifying a geometric intersection or collision between a distinct adaptive attire object and the canvas target, S240 may in turn function to modify the geometry of the distinct adaptive attire object by adjusting or setting the coordinates of one or more geometric features of the distinct adaptive attire object (e.g., vertices, edges, polygons, and/or the like) such that the identified geometric intersection or collision with the canvas target is remediated or nullified. In such embodiments, once the identified geometric intersection or collision with the canvas target is remediated or nullified, S240 may function to step or iterate to the subsequent adaptive attire object in the current layer and/or the subsequent adaptive attire object in the subsequent adaptive attire object layer of the layering sequence.

In some preferred embodiments, S240 may additionally or alternatively function to step or iterate through the layering sequence in a descending order (e.g., a top-down and/or outside-in sequence, relative to the canvas target). In such an embodiment, S240 may function to identify one or more geometric intersections or collisions between each distinct adaptive attire object in a current adaptive attire object layer and any adaptive attire object in any adaptive attire object layer above the current layer. In such embodiments, upon identifying a geometric intersection or collision between a distinct adaptive attire object and another conflicting adaptive attire object in an upper layer, S240 may function to modify the geometry of the distinct adaptive attire object by adjusting or shifting the coordinates of one or more geometric features of the distinct adaptive attire object (e.g., vertices, edges, polygons, and/or the like) inward relative to the canvas target and the conflicting adaptive attire object such that the geometric intersection or collision between the adaptive attire objects is remediated or nullified. In such embodiments, once the identified geometric intersection or collision between adaptive attire objects is remediated or nullified, S240 may function to step or iterate to the subsequent adaptive attire object in the current layer and/or the subsequent adaptive attire object in the subsequent adaptive attire object layer of the layering sequence.

In some preferred embodiments, S240 may additionally or alternatively function to step or iterate through the layering sequence in an ascending order (e.g., a bottom-up and/or inside-out sequence, relative to the canvas target). In such an embodiment, S240 may function to identify if any adaptive attire object in a higher layer is covered or occluded by an adaptive attire object in a lower adaptive attire object layer. In such embodiments, upon identifying such a covering or occlusion, S240 may function to modify the geometry of the adaptive attire object in the higher layer by adjusting or shifting the coordinates of one or more geometric features (e.g., vertices, edges, polygons, and/or the like) of the adaptive attire object in the higher layer outward relative to the canvas target and the adaptive attire object in the lower adaptive attire object layer until the occlusion or covering is remediated. In such embodiments, once the identified occlusion or covering between adaptive attire objects is remediated or nullified, S240 may function to step or iterate to the subsequent adaptive attire object in the current layer and/or the subsequent adaptive attire object in the subsequent adaptive attire object layer of the layering sequence. Accordingly, in such embodiments, S240 may function to enforce or ensure that adaptive attire objects in higher layers are not occluded or covered by adaptive attire objects in lower layers.

As a non-limiting example, S240 may function to modify one or more vertices and/or one or more polygons of one or more meshes (e.g., 3-D mesh objects) of each adaptive attire object such that the vertices, edges, and/or polygons of each mesh of each adaptive attire object do not intersect the geometric structure of the canvas target (e.g., a 3-D mesh of a virtual avatar). Additionally, in such an example, S240 may function to sequentially step or iterate through each adaptive attire object of each adaptive attire object layer in a defined layer order (e.g., top-to-bottom order, left-to-right order, and/or the like), and S240 may accordingly function to modify one or more vertices, edges, and/or polygons of one or more meshes of each mesh of each adaptive attire object in each adaptive attire object layer (e.g., by scaling or modifying vertices inward towards the canvas target) such that each mesh of each adaptive attire object does not intersect and/or does not geometrically interfere with any mesh in any adaptive attire object in any higher adaptive attire object layer (e.g., adaptive attire object layers above the current adaptive attire object layer). Additionally, in such an example, S240 may function to sequentially step or iterate through each adaptive attire object of each adaptive attire object layer in a defined reverse layer order (e.g., bottom-to-top order, right-to-left order, and/or the like), and S240 may accordingly function to modify one or more vertices of one or more meshes of each mesh of each adaptive attire object in each adaptive attire object layer (e.g., by scaling or modifying vertices inward towards the canvas target) such that each mesh of each adaptive attire object covers any underlying portion or portions of any mesh in any adaptive attire object in any lower adaptive attire object layer (e.g., adaptive attire object layers below the current adaptive attire object layer).

In some preferred embodiments, S240 may function to modify only vertices, edges, and/or polygons of each mesh that intersect or otherwise geometrically interfere with the geometry of other adaptive attire objects; that is, in such an example, S240 may function to selectively identify and modify interfering portions or subsections of one or more meshes or adaptive attire object geometries, rather than scaling or modifying an entire mesh or entire adaptive attire object geometry.

In one or more embodiments, S240 may function to modify the augmented avatar ensemble data structure by storing any modifications to the geometric features of the one or more adaptive attire objects as augmenting data and/or augmenting metadata associated with the corresponding adaptive attire objects in the avatar ensemble data structure. Accordingly, in such embodiments, the augmented avatar ensemble data structure may include coordinates or values that may relate to or define one or more modifications to one or more adaptive attire objects. In such embodiments, the augmented avatar ensembled data structure may additionally include the original or pre-modified geometry data (e.g., vertex data, polygon data, and/or the like) for each of the one or more adaptive attire objects, such that one or more adaptive attire objects may be associated with an unmodified geometry (based on the original or pre-modified geometry data) and a modified geometry (based on the augmenting data and/or metadata).

It shall be noted that, in one or more embodiments, S240 may function to modify the one or more adaptive virtual attire objects in real-time relative to configuring the adaptive virtual attire object layering sequence S230. That is, in one or more embodiments, S240 may function to automatically modify the one or more adaptive virtual attire objects to reflect any changes in the object layering sequence due to an iteration and/or execution of S230. Accordingly, in some such embodiments, any change in the layering sequence (e.g., an execution of S230) may result in a subsequent and/or immediate execution of a modifying of one or more adaptive attire objects based on the changes to the layering sequence (e.g., an execution of S240). Therefore, in some such embodiments, a user modification of the layering sequence via the user interface may be subsequently and/or simultaneously displayed visually by a modifying of one or more adaptive attire objects in the digital avatar configuration environment user interface.

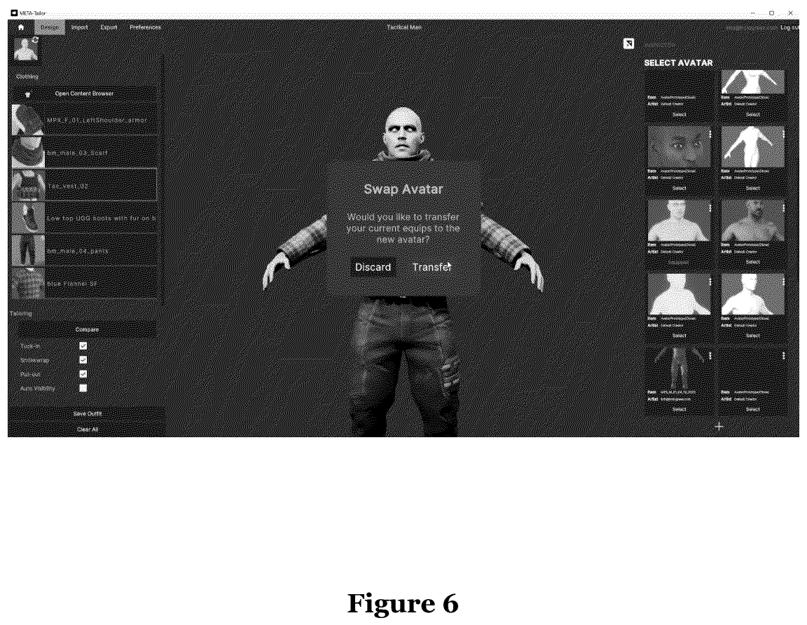

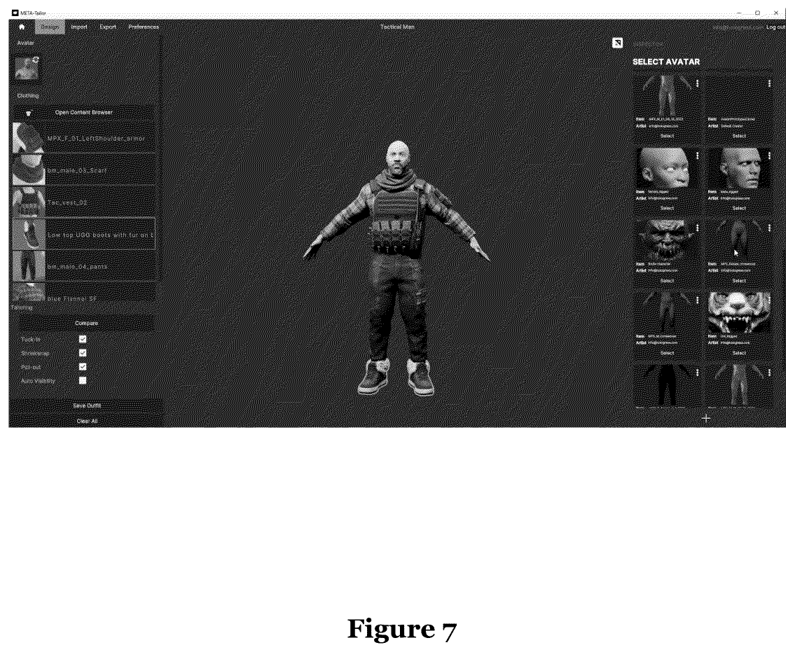

Additionally, it shall be noted that, in one or more embodiments, S240 may function to maintain the layering sequence if the canvas target or the virtual avatar asset associated with the canvas target is changed, as shown by way of example in FIGS. 6-7. As a non-limiting example, a user may use the digital avatar customization environment interface to select and/or switch the virtual avatar of the canvas target to a new or subsequent virtual avatar (as described in 2.05). In such a non-limiting example, the layering sequence established by S230 may be maintained, and the one or more adaptive attire objects may be mapped onto the new or subsequent virtual avatar (according to S220, as described in 2.2) and S240 may function to modify the one or more adaptive attire objects according to the layer sequence and the new or subsequent virtual avatar. Accordingly, in such a non-limiting example, method 200 may enable real-time or runtime switching of virtual avatars while automatically maintaining the configured layering sequence of the one or more adaptive attire objects, without the need for reconfiguring the layering sequence and/or reimporting or re-introducing the adaptive attire objects to the digital avatar customization environment.

### 2.5 Generating an Augmented Avatar Ensemble Digital Artifact

S250, which includes generating an augmented avatar ensemble digital artifact, may function to generate, construct, and/or save or store an augmented avatar ensemble digital artifact based on the augmented avatar ensemble data structure that may be ported to one or more digital platforms for real-time or runtime deployment. As generally referred to herein, the augmented avatar ensemble digital artifact (ensemble digital artifact) may relate to a digital artifact that may include the augmented avatar ensemble data structure for a particular canvas avatar target, and may include one or more pieces of data relating to the virtual avatar appearance of the canvas avatar target (e.g., geometry data, texture/material data, animation data, and/or the like of the canvas avatar target) and one or more pieces of data relating to one or more adaptive attire objects mapped to the canvas avatar target (e.g., geometry data, texture/material data, animation data, and/or the like of the one or more adaptive attire objects). Additionally, in one or more preferred embodiments, the ensemble digital artifact may include one or more layering sequences or layering sequence data.

Preferably, the augmented avatar ensemble digital artifact may be generated based on the data included in the augmented avatar ensemble data structure. In some preferred embodiments, the ensemble digital artifact may include augmenting data and/or metadata as well as the original or pre-modified data and/or metadata associated with each of the adaptive attire objects included in the ensemble digital artifact. Accordingly, in such embodiments, the ensemble digital artifact may function to non-destructively store each adaptive attire object by including the original, pre-modified state of each adaptive attire object along with post-modified states of each adaptive attire object.

In some preferred embodiments, the ensemble digital artifact may be generated and/or configured to be deployed in a runtime or real-time environment. In some such embodiments, the ensemble digital artifact may function to permit further modifications or adjustments to the adaptive attire objects and/or the layering sequences in the runtime or real-time environments in which the ensemble digital artifact is deployed.

In one or more embodiments, generating an augmented avatar ensemble digital artifact may be initiated by a user (e.g., via a selecting a button, icon, or other selectable interface object in the digital avatar configuration environment interface). Alternatively, in some embodiments, S250 may function to automatically initiate a generating of an augmented avatar ensemble digital artifact based on one or more digital artifact generating conditions. In various embodiments, digital artifact generating conditions may include, but may not be limited to, identifying that a time elapsed since last generating an ensemble digital artifact exceeds a temporal threshold, identifying that a change in the augmented avatar ensemble data structure has occurred, and/or any other suitable condition for automatically generating or saving a digital artifact.

### Additional Method Features

Method 200 provides a series of processes for dynamically layering, adjusting, and transferring virtual attire objects on a digital avatar within a virtual entity design computing environment. Method 200 encompasses steps for rendering a virtual entity, applying attire objects in a user-determined sequence, managing metadata, and exporting the configured data to external interactive environments. The following steps provide further detail to ensure comprehensive coverage of the claimed processes.

### Rendering a Virtual Entity

Method 200 may begin by rendering a virtual entity within a virtual entity design computing environment, where the entity may be represented as a three-dimensional geometric model. This rendering step serves as the foundation for subsequent customization and attire layering processes, allowing the user to visualize and interact with the avatar in a simulated 3D environment.

### Application of Attire Objects in User-Determined Sequence

Method 200 may include a process for applying multiple attire objects to the virtual entity in a sequence determined by the user. This step may involve placing attire objects onto designated regions of the virtual entity's geometry based on user inputs, enabling customization of the avatar's appearance. Each attire object may represent a distinct item, such as clothing or accessories, which may be arranged to achieve the desired visual configuration. The sequence of application may impact the layering and visibility of each attire object.

### Deriving and Storing Object Sequencing Metadata

Upon applying attire objects, Method 200 may derive metadata identifying the specific order in which each object was applied. This sequencing metadata may capture the layering hierarchy and sequence chosen by the user, which may be stored for later use in the transferrable data container. The sequencing metadata may enable consistent reassembly and layering of attire objects when transferred to external virtual environments.

### Configuring a Transferrable Data Container

Method 200 may configure a transferrable data container that stores representations of the attire objects, object sequencing metadata, and additional attributes. This container may employ a multi-dimensional structure that includes unique identifiers for each attire object, positional coordinates, material properties, and other relevant data. The data container may ensure that the avatar's configuration can be exported and reconstituted in a separate interactive environment.

### Fitting Attire Objects to Geometric Regions of the Virtual Entity

Method 200 may include a step for fitting each attire object to designated geometric regions on the virtual entity, adapting the attire object's size, position, and orientation to align with the target geometry. This process may involve resizing each attire object from an initial n-dimensional size to a modified n-dimensional size that conforms to the virtual entity's contours, thereby ensuring that each attire object fits accurately.

### Identifying and Storing Positional Coordinates

For each attire object, Method 200 may identify specific n-dimensional coordinates based on its placement on the virtual entity. These coordinates, which may define the spatial position of each attire object relative to the avatar, may be stored in the transferrable data container, allowing for precise recreation of the attire configuration in external environments.

### Analyzing and Resolving Geometric Intersections

Method 200 may involve analyzing potential geometric intersections between adjacent attire objects and between attire objects and the virtual entity itself. Upon detecting an intersection, Method 200 may modify the geometry of one or more attire objects to resolve the overlap or interference. This may include shifting vertices or adjusting dimensions to prevent visual inconsistencies, ensuring that the attire objects layer seamlessly without collision.

### Generating Platform-Agnostic Data Formats for Transmission

Method 200 may further include a step for preparing the transferrable data container in a platform-agnostic format. This may enable the data to be exported to various interactive virtual environments without compatibility issues, ensuring that the layered attire configuration may be rendered consistently across different platforms.

### Storing History of Modifications

In one embodiment, Method 200 may include a step for storing a history of modifications to each attire object's coordinates within the transferrable data container. This may enable the user to revert to prior configurations, providing flexibility and undo functionality for iterative customization.

### Adding Material Properties and Attributes to the Data Container

Method 200 may include the addition of material properties and other attributes for each attire object in the transferrable data container. These properties, which may include texture, color, and reflectivity, may ensure that the visual characteristics of each attire object are preserved across different environments.

### Providing Real-Time Adjustment of Attire Objects

A user interface may be provided by Method 200 for real-time adjustments to each attire object's position, orientation, and layering sequence. This user interface may allow the user to alter the attire configuration interactively, with immediate updates to the object sequencing metadata as modifications are made. This real-time feedback may enhance the user experience and support iterative design.

### Storing Procedural Data for Automatic Adjustment

In some embodiments, Method 200 may include a step for storing procedural data within the transferrable data container, which may define rules for automatic adjustment of attire objects based on changes in the virtual entity's pose or movement. This may ensure that attire objects remain properly aligned and positioned as the avatar's orientation or motion changes within the interactive environment.

### Exporting the Augmented Avatar Ensemble to Interactive Environments

The final step in Method 200 may be to enable the export or transmission of the transferrable data container to one or more external interactive environments. This process may allow the customized avatar, including its layered attire and positional data, to be deployed in real-time or runtime applications, preserving the configured appearance and behavior.

### Non-Destructive Data Storage

Throughout Method 200, the system may employ a non-destructive storage approach for the transferrable data container, maintaining both original and modified states of each attire object. This may allow for flexibility in editing while preserving initial configurations, ensuring that users may revert changes as needed.

### 3. Computer-Implemented Method and Computer Program Product

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

We claim:

1. A computer-implemented method comprising:
rendering, by one or more computer processors implementing a virtual entity design computing environment, a virtual entity comprising a three-dimensional digital representation of a geometric model;
applying, by the one or more computer processors in a user-determined sequence, a plurality of attire objects onto the virtual entity based on a plurality of inputs of a user;
in response to the application of the plurality of attire objects:
deriving object sequencing metadata based on the user-determined sequence, the object sequencing metadata identifying an order in which each of the plurality of attire objects was applied to the virtual entity, and
configuring, by the one or more computer processors, a transferrable data container that stores a representation of the plurality of attire objects and object sequencing metadata;
enabling a transmission of the transferrable data container to an interactive virtual environment different from the virtual entity design computing environment.

2. The method according to claim 1, further comprising:
fitting each attire object of the plurality of attire objects to a given geometric region of a plurality of geometric regions of the virtual entity, wherein the fitting of each attire object causes the respective attire object to change from a first n-dimensional geometric size to a second n-dimensional geometric size; and
wherein configuring, by the one or more computer processors, the transferrable data container further includes storing, within the transferrable data container, the second n-dimensional geometric size of each of the plurality of attire objects based on the fitting.

3. The method according to claim 1, further comprising:
identifying n-dimensional coordinates for each attire object of the plurality of attire objects based on a placement of the respective attire object onto a given geometric region of a plurality of geometric regions of the virtual entity; and
wherein configuring, by the one or more computer processors, the transferrable data container further includes storing, within the transferrable data container, the n-dimensional coordinates for each of the plurality of attire objects.

4. The method according to claim 1, wherein the transferrable data container comprises at least a two-dimensional data structure storing attributes associated with the plurality of attire objects
wherein the at least two-dimensional data structure includes:
at least a first dimension storing a unique identifier for or a representation of a given attire object of the plurality of attire objects; and
at least a second dimension storing one or more values of the attributes associated with the plurality of attire objects.

5. The method according to claim 4, wherein the attributes associated with the plurality of attire objects include the object sequence metadata, a second n-dimensional geometric size of a given attire object of the plurality of attire objects, or n-dimensional coordinates of a placement of a given attire object of the plurality of attire objects onto the virtual entity.

6. The method according to claim 1, further comprising:
analyzing, by the one or more computer processors, geometric intersections between a given attire object and an adjacent attire object of the plurality of attire objects placed on the virtual entity; and
modifying, by the one or more computer processors, a geometric configuration of the given attire object and the adjacent attire object to resolve the geometric intersections based on the user-determined sequence.

7. The method according to claim 1, wherein enabling the transmission of the transferrable data container further includes:
generating a platform-agnostic file format for the transferrable data container enabling the transferrable data container to be read and utilized by a plurality of different interactive virtual environments.

8. The method according to claim 2, wherein fitting each attire object further comprises:
performing collision detection between each attire object of the plurality of attire objects and the virtual entity to adjust the n-dimensional geometric size of a given attire object of the plurality of attire objects based on surface contours of the virtual entity.

9. The method according to claim 3, further comprising:
storing a history of modifications to the n-dimensional coordinates for each attire object of the plurality of attire objects stored within the transferrable container thereby enabling a user to revert to a previous configuration of a given attire object of the plurality of attire objects.

10. The method according to claim 4, wherein the transferrable data container further includes:
Metadata specifying material properties of each attire object of the plurality of attire objects, wherein the material properties include one or more of a texture of material, a color of material, and a reflectivity of material thereby ensuring consistency when rendered in the interactive virtual environment.

11. The method according to claim 1, further comprising:
providing, by the one or more computer processors, a user interface allowing the user to adjust a position or an orientation of a given attire object of the plurality of attire objects after applying the given attire object to the virtual entity, and automatically updating the object sequencing metadata based on the adjustment by the user.

12. The method according to claim 5, further comprising:
storing procedural data within the transferrable data container that define rules for automatically adjusting a position or a fit of a given attire object of the plurality of attire objects based on changes in a pose or a movement of the virtual entity in the interactive virtual environment.

13. A computer-implemented system comprising:
one or more computer processors;
a virtual entity design computing environment implemented by the one or more computer processors, configured to render a virtual entity comprising a three-dimensional digital representation of a geometric model;
a user interface module configured to receive, from a user, a plurality of inputs for applying a plurality of attire objects onto the virtual entity in a user-determined sequence;
an object sequencing module configured to derive object sequencing metadata based on the user-determined sequence, the object sequencing metadata identifying an order in which each of the plurality of attire objects was applied to the virtual entity;
a data container module configured to configure a transferrable data container that stores a representation of the plurality of attire objects and the object sequencing metadata; and
a transmission module configured to enable the transmission of the transferrable data container to an interactive virtual environment different from the virtual entity design computing environment.

14. The system according to claim 13, further comprising:
a fitting module configured to fit each attire object of the plurality of attire objects to a given geometric region of a plurality of geometric regions of the virtual entity, wherein the fitting of each attire object causes the respective attire object to change from a first n-dimensional geometric size to a second n-dimensional geometric size; and
wherein the data container module is further configured to store, within the transferrable data container, the second n-dimensional geometric size of each of the plurality of attire objects based on the fitting.

15. The system according to claim 13, further comprising:
a coordinate identification module configured to identify n-dimensional coordinates for each attire object of the plurality of attire objects based on a placement of the respective attire object onto a given geometric region of a plurality of geometric regions of the virtual entity; and
wherein the data container module is further configured to store, within the transferrable data container, the n-dimensional coordinates for each of the plurality of attire objects.

16. The system according to claim 13, wherein the transferrable data container comprises at least a two-dimensional data structure storing attributes associated with the plurality of attire objects, wherein the at least two-dimensional data structure includes:
at least a first dimension storing a unique identifier for or a representation of a given attire object of the plurality of attire objects; and
at least a second dimension storing one or more values of the attributes associated with the plurality of attire objects.

17. The system according to claim 16, wherein the attributes associated with the plurality of attire objects include the object sequencing metadata, a second n-dimensional geometric size of a given attire object of the plurality of attire objects, or n-dimensional coordinates of a placement of a given attire object of the plurality of attire objects onto the virtual entity.

18. A computer-program product comprising a non-transitory machine-readable medium comprising instructions that, when executed by a processor, perform operations comprising:
rendering, within a virtual entity design computing environment, a virtual entity comprising a three-dimensional digital representation of a geometric model;
applying, in a user-determined sequence, a plurality of attire objects onto the virtual entity based on a plurality of inputs from a user;
in response to the application of the plurality of attire objects:
deriving object sequencing metadata based on the user-determined sequence, the object sequencing metadata identifying an order in which each of the plurality of attire objects was applied to the virtual entity; and
configuring a transferrable data container that stores a representation of the plurality of attire objects and the object sequencing metadata;
enabling a transmission of the transferrable data container to an interactive virtual environment different from the virtual entity design computing environment.

19. The computer program product according to claim 18, wherein the instructions further cause the processors to:
fit each attire object of the plurality of attire objects to a given geometric region of a plurality of geometric regions of the virtual entity, wherein the fitting of each attire object causes the respective attire object to change from a first n-dimensional geometric size to a second n-dimensional geometric size; and
store, within the transferrable data container, the second n-dimensional geometric size of each of the plurality of attire objects based on the fitting.

20. The computer program product according to claim 18, wherein the instructions further cause the processors to:
identify n-dimensional coordinates for each attire object of the plurality of attire objects based on a placement of the respective attire object onto a given geometric region of a plurality of geometric regions of the virtual entity; and
store, within the transferrable data container, the n-dimensional coordinates for each of the plurality of attire objects.
